(19) United States
(12) Patent Application Publication
(10) Pub. No.: US 2018/0314544 A1
(43) Pub. Date: Nov. 1, 2018

(54) COMBINING DATA BLOCKS FROM VIRTUAL MACHINES

(71) Applicant: Hewlett-Packard Development Company LP, Houston, TX (US)

(72) Inventor: Siamack Ayandeh, Andover, MA (US)

(73) Assignee: Hewlett Packard Enterprise Development LP, Houston, TX (US)

(21) Appl. No.: 15/770,140

(22) PCT Filed: Oct. 30, 2015
(86) PCT No.: PCT/US15/58443

§ 371 Date: Apr. 20, 2018

(51) Int. Cl. G06F 9/455; H04L 29/08

(52) U.S. Cl. CPC G06F 9/45558; H04L 67/1097; G06F 2009/45583; G06F 2009/45595; G06F 2009/45579

(57) ABSTRACT

In example implementations, an apparatus is provided. The apparatus may include a processor to execute a plurality of virtual machines (VMs). A hypervisor in communication with the plurality of VMs may create a hypervisor input and output (IO) block having a plurality of virtual machine (VM) data blocks. At least two VM data blocks of the plurality of VM data blocks are from at least two different VMs of the plurality of VMs. The apparatus may also include a fabric input and output interface to a storage area network to transmit the hypervisor IO block as a frame payload to a storage appliance.

### BACKGROUND

Cloud based computing solutions are becoming more popular. The cloud based solutions provide virtualized environments that can allow different customers to share and use a large pool of resources without having to pay the high capital investment to buy the hardware on their own. The performance of the virtualized environment can be dependent upon a variety of different factors. Some of the factors that affect the performance of the virtualized environment may include latency, throughput and input output operations per second of storage devices.

### BRIEF DESCRIPTION OF THE DRAWINGS

FIG. 1 is a block diagram of an example network of the present disclosure;

FIG. 2 is a block diagram of an example host of the present disclosure;

FIG. 3 is a block diagram of an example hypervisor with an affinity table of the present disclosure;

FIG. 4 is a flow diagram of an example method for combining data blocks from different virtual machines; and

FIG. 5 is a block diagram of an example apparatus of the present disclosure.

### DETAILED DESCRIPTION

The present disclosure provide techniques that improve the efficiency of read and write operations to storage devices in a cloud computing environment. One measure of the efficiency of the cloud computing environment is input output operations per second (IOPS). The present disclosure combines virtual machine (VM) data blocks from different virtual machines (VMs) into a single input output (IO) block of a hypervisor.

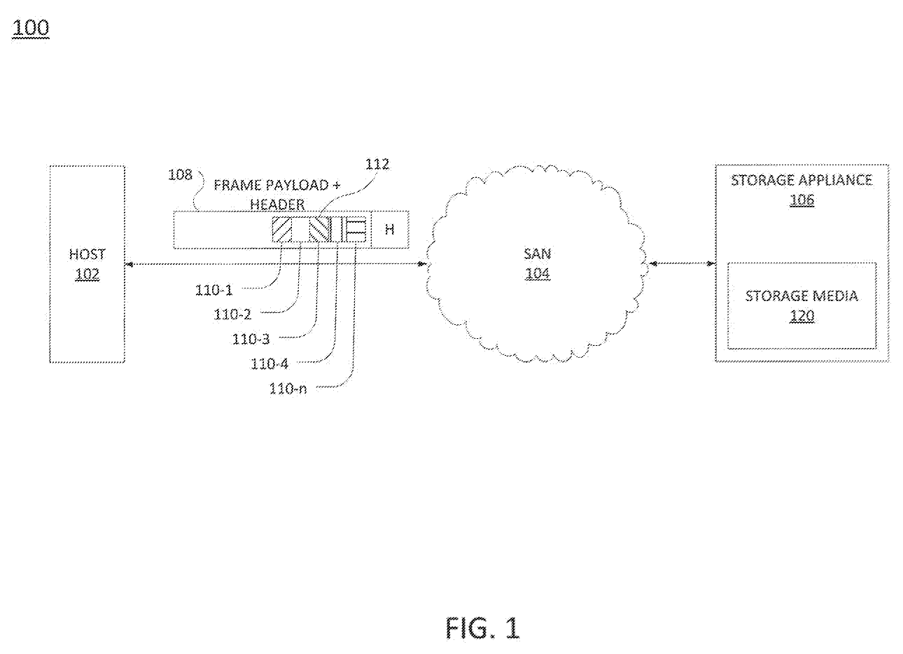

FIG. 1 illustrates a block diagram of an example network 100 of the present disclosure. In one example, the network 100 may be a datacenter node. In one example, the network 100 may include a host 102 in communication with a storage appliance 106 over a storage area network (SAN) 104. In one example, the storage appliance 106 may include a storage media 120 or an array of storage media 120. The storage appliance 106 may be a storage server, a hard disk drive, a solid state drive, network interface cards, and the like.

In one example, the storage appliance 106 may include a controller node and a network card to communicate over the SAN 104. The communication protocol used by the network card of the storage appliance 106 may include protocols such as a Fibre Channel, a Fiber Channel over Ethernet (FCoE), Internet Small Computer System Interface (iSCSI), and the like.

In one example, the host 102 may send a frame payload 108. The frame payload 108 may include a header and a payload section which includes a hypervisor IO block 112. The hypervisor IO block 112 may include a plurality of VM data blocks 110-1 to 110-n (herein referred to individually as a VM data block 110 or collectively as VM data blocks 110). In one example, the VM data blocks 110 may be from two or more different VMs of the host 102.

In one example, the hypervisor IO blocks 112 may be unpacked from the frame payload 108 at the storage appliance 106 and converted into storage media IO blocks. The minimum storage media IO block size for a single input and output operation (IOP) may be approximately 4 kilobytes (KB), which may be larger than a block size of the VM data blocks 110.

Previously, the host 102 would send IO blocks 112 that included VM data blocks 110 from a single VM without filling the entire space of the hypervisor IO block 112. If the host 102 waited until the hypervisor IO block 112 was full, the amount of latency may not be acceptable. Thus, the host 102 would previously transmit hypervisor IO blocks 112 that are not full to minimize latency.

In addition, the hypervisor IO blocks 112 would include VM data blocks 110 having a small number of bytes of data (e.g., less than the maximum allowed payload size of the frames used by the SAN 104). In addition, the frame payload may include many hypervisor IO blocks 112 where each hypervisor IO block 112 is from a single VM. As a result, previous networks would transfer less bytes for the same number of frame payloads 108. Also the storage appliance 106 would read and write less data bytes for the same number of IOPS.

However, the present disclosure combines the VM data blocks 110 from different VMs into a single hypervisor IO block 112. The full size, or full capacity, of the hypervisor IO block 112 may be used. By using the full capacity of the hypervisor IO block 112, both the SAN 104 and the storage appliance 106 may be used more efficiently without adding latency to applications executed by the host 102.

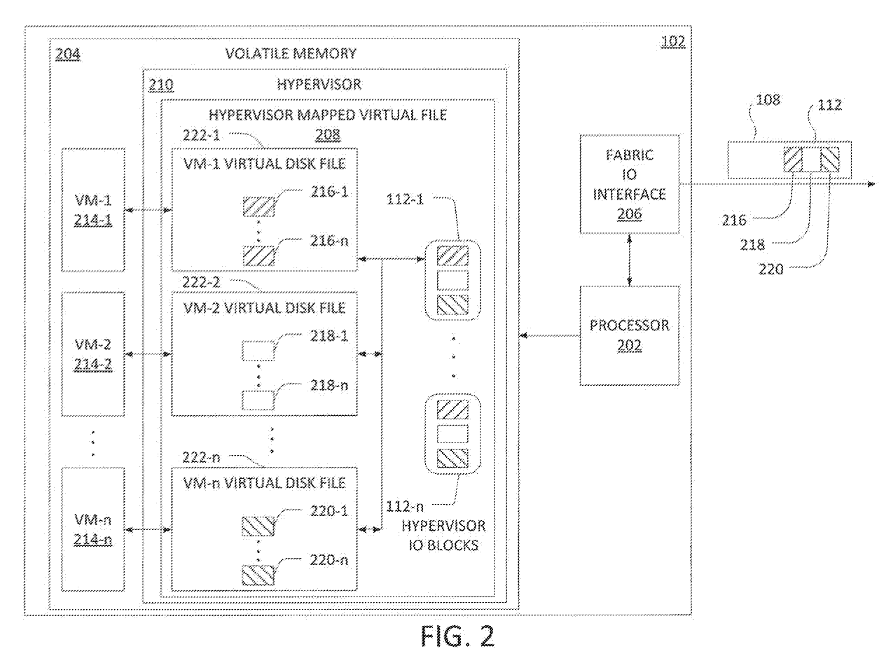

FIG. 2 illustrates an example block diagram of the host 102. In one example, the host 102 may include a processor 202, a fabric input and output (IO) interface 206 and a volatile memory 204. In one example, the fabric IO interface 206 may attach to a collection of switches in the SAN 104. For example, the fabric IO interface 206 may be network interface cards, host bus adaptors, and the like. The fabric IO interface 206 may transmit the hypervisor IO block 112 as a frame payload 108 to the storage appliance 106 over the SAN 104.

In one example, the processor 202 may execute logic and functions stored in the volatile memory 204. In one example, the volatile memory 204 may include a hypervisor 210 and a plurality of VMs 214-1 to 214-n (herein referred to individually as a VM 214 or collectively as VMs 214). The hypervisor 210 may include a hypervisor mapped virtual file 208 that supports the plurality of VMs 214-1 to 214-n.

In one example, each VM 214-1 to 214-n may be allocated a respective VM virtual disk file 222-1 to 222-n (herein after referred to individually as a VM virtual disk file 222 or collectively as VM virtual disk files 222) within the hypervisor mapped virtual file 208. Each one of the VM virtual disk files 222 may have a respective VM data block 110. For example, the VM virtual disk file 222-1 may have VM data blocks 216-1 to 216-n (herein referred to individually as a VM data block 216 or collectively as VM data blocks 216), the VM virtual disk file 222-2 may have VM data blocks 218-1 to 218-n (herein referred to individually as a VM data block 218 or collectively as VM data blocks 218), and the VM virtual disk file 222-n may have VM data blocks 220-1 to 220-n (herein referred to individually as a VM data block 220 or collectively as VM data blocks 220).

It should be noted that VM block 110 may refer to VM blocks in general. VM blocks 216, 218 and 220 may refer to a VM block from a particular VM 214.

The hypervisor 210 may be in communication with each one of the plurality of VMs 214. In one example, the hypervisor 210 may create the hypervisor IO block 112-1 to hypervisor IO block 112-n (hereinafter referred to individually as hypervisor IO block 112 or collectively as hypervisor IO blocks 112). The hypervisor IO blocks 112 may comprises a block size of 4,096 bytes or approximately 4 KB. The hypervisor 210 may combine VM data blocks 216, 218 and 220 into a single hypervisor IO block 112 using various techniques, as described in further detail below.

The VM data blocks 216, 218 and 220 may have a small size (e.g., 256 bytes). The hypervisor 210 may combine the data blocks 216, 218 and 220 from the different VMs 214-1, 214-2 and 214-n, respectively, to use the full capacity of the hypervisor IO block 112 without affecting the application latency.

In addition, by using the full capacity of the hypervisor IO block 112, the full capacity of the frame payload 108 (e.g., approximately 9 KB) may be used. In one implementation, the number of VM data blocks 216, 218 and 220 that can be sent in the hypervisor IO blocks 112 may be based on a minimum block size of a storage media IO block size used by the storage media 120. For example, the hypervisor 210 may combine the VM data blocks 216, 218 and 220 to create two IO blocks 112 that are a full size of the storage media IO block and transmit the two hypervisor IO blocks 112 using the frame payload 108.

For example, non-volatile memory (NVM) may have a minimum block size of approximately 4 KB for reading and writing to the medium. Transactional workloads running as applications within the VMs 214 may have VM data blocks 110 that are often less than 4 KB. For example, the VM data blocks 110 generated by the transactions of the VMs 214 can have sizes that are 256 to 512 bytes. Therefore, 8 to 16 transactions can fit in one hypervisor IO block 112 for write and read to the NVM storage.

Furthermore using a frame payload which is approximately 9 KB, as described above, two hypervisor IO blocks 112 can be carried in a single frame payload 108. This may be more efficient than carrying eight 1 KB frames as switching one large frame uses less packet per second processing than carrying eight frames when they are all going to the same destination.

At the destination storage media 120 in the storage appliance 106, the hypervisor IO block 112 results in two writes to NVM versus 8 to 16. Hence, the number of IOPS is reduced.

Furthermore, by packing VM data blocks 216, 218 and 220 from different VMs 214 into a single IO block 112, the time to permanence is reduced for individual transactions. Without the techniques of the present disclosure, the hypervisor would have to buffer enough transactions from a single VM 214 to fill a hypervisor IO block 112 to achieve the same level of efficiency. This adds latency to applications run by the VMs 214.

In addition, memory is volatile. Power loss or a number of other events may result in the loss of the buffered transactions. If the buffered transactions are lost, the applications would regenerate the transactions. The regeneration of the transactions may increase the latency of the applications.

Since VM data blocks 216, 218 and 220 from different VMs 214 are packed into a single hypervisor IO block 112, each VM data block 216, 218 and 220 may store identification information of a respective VM 214. For example, each data block 216 may include identification information of the VM 214-1, each data block 218 may include identification information of the VM 214-2, and so forth.

In some implementations, the identification information may be stored in the VM data blocks 216, 218 and 220 with a format that may include a virtual machine identification, a virtual logical unit number (LUN), a pointer to a data block and a data block size. The virtual machine ID may be 2 bytes, the virtual LUN may be 8 bytes, the pointer to the data block may be 4 bytes and the data block size may be 4 bytes.

The virtual machine identification may be obtained from a virtual machine universal unique identification (UUID), which in turn points to a virtual machine display name. The virtual machine display name may be an ASCI string that is a user friendly display name. The virtual machine UUID may be a unique instance identifier that is 16 bytes.

The identification information of the respective VM 214 may be used by a storage appliance 120 that receives the frame payload 108. For example, the storage appliance 120 may use the identification information to identify the respective VM 214 associated with the VM data blocks 216, 218 and 220 in the IO block 112 so that the VM data blocks 216, 218 and 220 can be distributed accordingly.

In some implementations, the hypervisor 210 may map and control the VMs 214. The hypervisor 210 may map each one of the plurality of VMs 214 to a respective virtual disk file within the hypervisor mapped virtual file 208 of the hypervisor 210. As a result, the plurality of VMs 214 may appear to the storage media 120 of the storage appliance 106 as a single client.

In one example, the hypervisor 210 and the plurality of VMs 214 may be any combination of hardware and programming to implement the functionalities of the hypervisor 210 and the VMs 214 described herein. In examples described herein, such combinations of hardware and programming may be implemented in a number of different ways. For example, the programming for the hypervisor 210 and the plurality of VMs 214 may be processor executable instructions stored on at least one non-transitory machine-readable storage medium and the hardware for the hypervisor 210 and the plurality of VMs 214 may include the at least one processing resource (e.g., the processor 202) to execute those instructions. In some examples, the hardware may include other electronic circuitry to at least partially implement the hypervisor 210 and/or the plurality of VMs 214.

As discussed above, various techniques can be used to combine the VM data blocks 216, 218 and 220 into a single hypervisor IO block 112. The techniques used by the hypervisor 210 to combine the VM data blocks 216, 218 and 220 from the different VMs 214-1 to 214-n, respectively, may be determined based on an application workload and requirements. It should be noted that the techniques described herein are provided as examples and other techniques may be within the scope of the present disclosure.

In one example, the VM data blocks 216, 218 and 220 of the VMs 214 may be randomly selected. In another example, a round robin method may be used. For example, a VM data block 216-1 may be selected from the VM 214-1, a VM data block 218-1 may be selected from the VM 214-2, and so forth, up to a VM data block 220-1 from the last VM 214-n. Then the process may be repeated beginning with the VM data block 216-2 of VM 214-1, then VM data block 218-2 of VM 214-2, and so forth. A VM 214 may be skipped if the VM 214 has no VM data block 216, 218 or 220 to offer.

In another example, a first come first serve method may be used. For example, as soon as a VM 214 has a VM data block 216, 218 or 220 to offer, the hypervisor 210 may add the VM data block 216, 218 or 220 to the hypervisor IO block 112.

In another example, the hypervisor 210 may select, based on a type of data, which VMs 214-1 to 214-n to receive VM data blocks 216, 218 or 220 from to be combined into a single hypervisor IO block 112. For example, VM 214-1 and VM 214-2 may be collecting temperature data of various geographic locations. As a result, the VM data blocks 216 and 218 may be temperature data that are of a similar type of data. The hypervisor 210 may combine VM data blocks 216 and 218 from the VMs 214-1 and 214-2 based on the similar type of data (e.g. temperature data) that the VMs 214-1 and 214-2 generate.

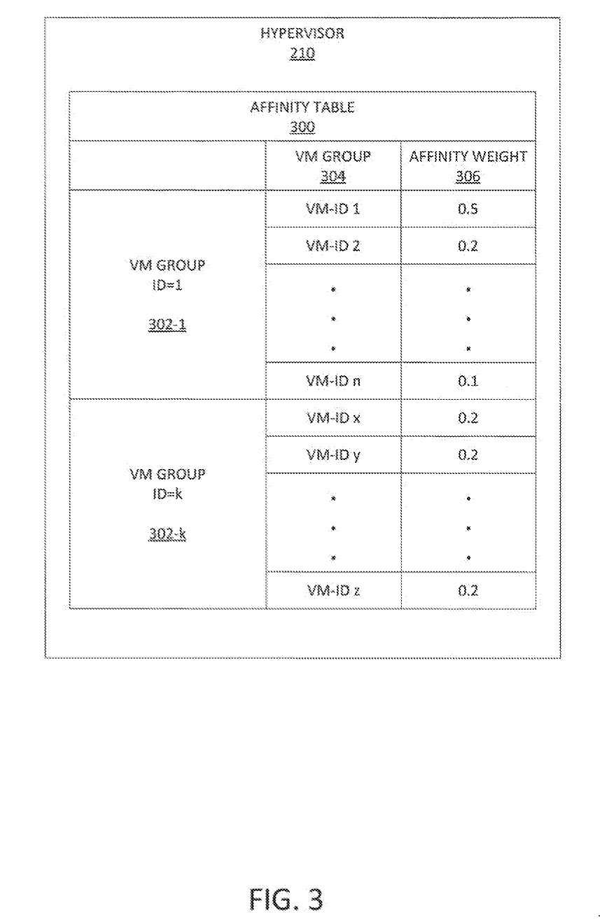

In another example, the hypervisor 210 may select, based on an affinity table, which VMs 214-1 to 214-n to receive VM data blocks 216, 218 or 220 from to be combined into a single IO block 112. FIG. 3 illustrates an example affinity table 300 that may be stored in the hypervisor 210. Affinity between two or more VMs 214 may be defined as a relationship between two or more VMs 214. For example, VM 214-1 and VM 214-2 may work on an application, but be assigned to track different data for the application. As a result, there would be an affinity between VM 214-1 and VM 214-2, even though VM 214-1 and VM 214-2 may store different types of data.

In one implementation, the affinity table 300 may include rows 302-1 to 302-k that includes groups of VMs. In one example, each group of VMs 1 to k may include a plurality of VMs 214 listed in a column 304 labeled as “VM group.”

The affinity table 300 may also include a column 306 labeled “affinity weight.” The affinity weight may provide a value that determines how the data generated by the VMs 214 should be distributed within the IO block 112. For example, the affinity weight may be a value between 0 and 1 and the sum of the affinity weight values for each VM group 302-1 to 302-k may equal 1. In other implementations, the affinity weight may be ratio values. For example, the ratio values may reflect a ratio of VM data blocks from a particular VM compared to other VMs within a VM group 302-1 to 302-k.

In one implementation, the affinity table 300 may be generated by a hypervisor management interface (e.g., a graphical user interface in communication with the host 102). A user may interact with the hypervisor management interface to configure various parameters of the hypervisor 210 based on applications and workloads. For example, the user via the hypervisor management interface may select which VMs 214 are to be included in each VM group 302-1 to 302-k based upon an application that is worked on by the VMs 214. In another example, the user via the hypervisor management interface may provide the affinity weight values in the column 306.

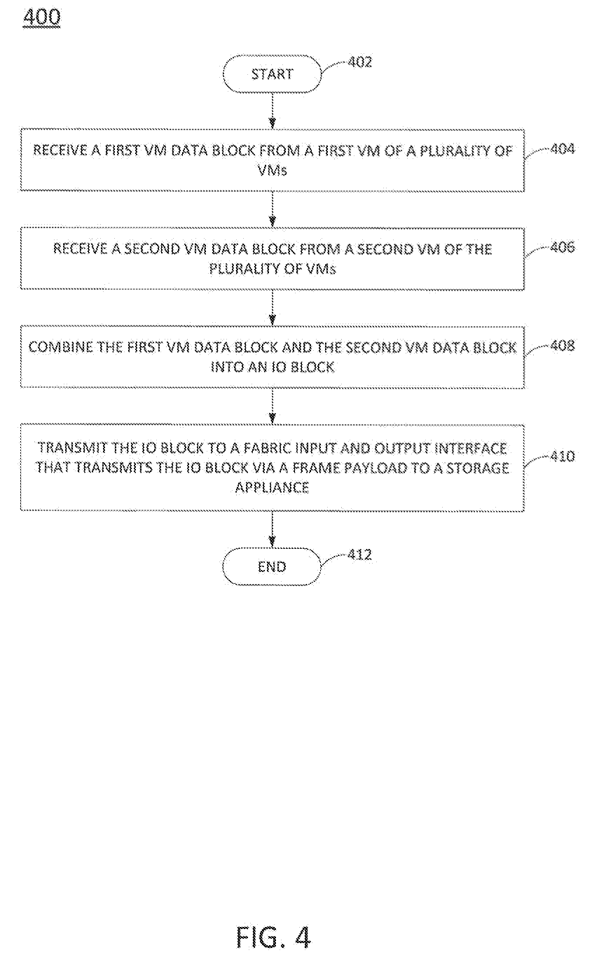

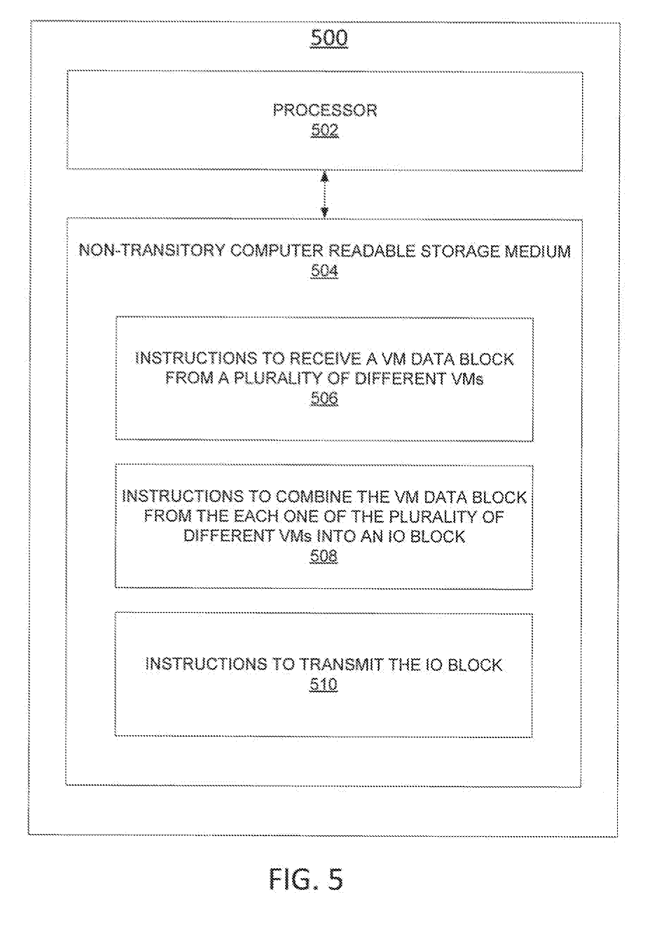

FIG. 4 illustrates a flow diagram of an example method 400 for combining VM data blocks from different virtual machines. In one example, the blocks of the method 400 may be performed by the host 102, the hypervisor 210 or the apparatus 500 described below in FIG. 5.

At block 402, the method 400 begins. At block 404, the method 400 receives a first VM data block from a first VM of a plurality of VMs. In one example, any of the techniques described above may be used to select the first VM from which the first VM data block is received. For example, the selection may be random selection, a round robin method, a first come first serve method, based on a type of data generated by the plurality of VMs, based on an affinity table, and the like.

At block 406, the method 400 receives a second VM data block from a second VM of the plurality of VMs. In one example, the second VM that is selected may be based on the same technique that was used to select the first VM.

In one example, additional VM data blocks may be received from additional different VMs of the plurality of VMs. For example, a plurality of VM data blocks may be received from each one of the plurality of VMs until a number of VM data blocks sufficient to fill a hypervisor IO block is received.

At block 408, the method 400 combines the first VM data block and the second VM data into a hypervisor IO block. In one example, if additional VM data blocks were received from other VMs, then the first VM data block, the second VM data block and the additional plurality of VM data blocks may be combined into a single hypervisor IO block.

In one implementation, since different VM data blocks are received from different VMs, each VM data block may store identification information of a respective VM. The identification information may be used by a storage appliance to identify the VM associated with each VM data block so that the VM data blocks can be distributed accordingly.

At block 410, the method 400 transmits the hypervisor IO block to a fabric input and output interface that transmits the hypervisor IO block via a frame payload to a storage appliance. In one example, multiple hypervisor IO blocks may be packed into the frame payload. For example, two hypervisor IO blocks each containing VM data blocks from different VMs may be packed into a single frame payload. The frame payload may be transmitted over a SAN to the storage appliance. At block 412, the method 400 ends.

FIG. 5 illustrates another example of an apparatus 500. In one example, the apparatus 500 may also be the host 102 or the hypervisor 210.

In one example, the apparatus 500 may include a processor 502 and a non-transitory computer readable storage medium 504. The non-transitory computer readable storage medium 504 may include instructions 506, 508 and 510 that when executed by the processor 502, cause the processor 502 to perform the functions described above.

In one example, the instructions 506 may include instructions to receive a VM data block from a plurality of different VMs. The instructions 508 may include instructions to combine the VM data block from the each one of the plurality of different VMs into a hypervisor IO data block. The instructions 510 may include instructions to transmit the hypervisor IO data block.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a processor to execute a plurality of virtual machines (VMs);
a hypervisor in communication with the plurality of VMs to create a hypervisor input and output (IO) block having a plurality of virtual machine (VM) data blocks, at least two VM data blocks of the plurality of VM data blocks being from at least two different VMs of the plurality of VMs; and
a fabric input and output interface to a storage area network to transmit the IO block as a frame payload to a storage appliance.

2. The apparatus of claim 1, wherein a selection, by the hypervisor, of the at least two different VMs of the plurality of VMs is based on a similarity between a type of data generated by the at least two different VMs of the plurality of VMs.

3. The apparatus of claim 1, comprising:
an affinity table stored in the hypervisor, wherein the affinity table contains a pre-defined relationship between two or more of the plurality of VMs.

4. The apparatus of claim 3, wherein a selection, by the hypervisor, of the at least two different VMs of the plurality of VMs is based on the affinity table.

5. The apparatus of claim 1, wherein a maximum number of the plurality of VM data blocks in the hypervisor IO block is based on a minimum block size of a storage media IO block.

6. The apparatus of claim 1, wherein each one of the plurality of VM data blocks stores identification information of a respective VM, wherein the identification information is stored in a format comprising a virtual machine identification, a virtual logical unit number, a pointer to a data block and a data block size.

7. A method, comprising:
receiving, using a processor, a first virtual machine (VM) data block from a first VM of a plurality of virtual machines (VMs);
receiving, using the processor, a second VM data block from a second VM of the plurality of VMs;
combining, using the processor, the first VM data block and the second VM data block into a hypervisor input and output (IO) block; and
transmitting, using the processor, the hypervisor IO block to a fabric input and output interface that transmits the hypervisor IO block via a frame payload to a storage appliance.

8. The method of claim 7, wherein the first VM and the second VM are selected based on a similarity between a type of data generated by the first VM and the second VM.

9. The method of claim 7, wherein the first VM and the second VM are selected based on an affinity between the first VM and the second VM.

10. The method of claim 9, wherein the affinity is based on an affinity table of the plurality of VMs stored in a hypervisor.

11. The method of claim 7, comprising:
receiving, using the processor, a plurality of VM data blocks from each one of the plurality of VMs; and
combining, using the processor, the first VM data block, the second VM data block, and the plurality of VM data blocks into the hypervisor IO block before the transmitting.

12. A non-transitory computer readable storage medium encoded with instructions executable by a processor, the non-transitory computer-readable storage medium comprising:
instructions to receive a virtual machine (VM) data block from a plurality of different virtual machines (VMs);
instructions to combine the VM data block from the each one of the plurality of different VMs into a hypervisor input and output (IO) block; and
instructions to transmit the hypervisor IO block containing a plurality of VM data blocks to a fabric input and output interface that transmits the hypervisor IO block via a frame payload over a storage area network to a storage appliance.

13. The non-transitory computer readable storage medium of claim 12, wherein the plurality of different VMs comprises a first VM and a second VM that are selected based on a similarity between a type of data generated by the first VM and the second VM.

14. The non-transitory computer readable storage medium of claim 12, wherein the plurality of different VMs comprises a first VM and a second VM that are selected based on an affinity table stored in a hypervisor.

15. The non-transitory computer readable storage medium of claim 12, wherein each one of the plurality of VM data blocks stores identification information of a respective VM.
